(19) United States
(12) Patent Application Publication
(10) Pub. No.: US 2008/0046264 A1
(43) Pub. Date: Feb. 21, 2008

(54) Novel Sales Methodology

(76) Inventor: Richard Rudnick, Bend, OR (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/695,642

(22) Filed: Apr. 3, 2007

Related U.S. Application Data
(60) Provisional application No. 60/813,522, filed on Jun. 14, 2006.

(51) Int. Cl. G06Q 10/00

(52) U.S. Cl. 705/1

(57) ABSTRACT

A comprehensive method for sales comprising an assignment of the individual's behavior, values and sales skills; the establishment of goals; the implementation of sales systems and tools to achieve the goods; and tracking; and implementing at least one additional sales technique.

### CROSS REFERENCE TO RELATED APPLICATION

This application claims benefit to provisional application 60/813,522 filed on Jun. 14, 2006, entitled Novel Sales Methodology, which is incorporated by referenced herein in its entirety.

### FIELD OF THE INVENTION

The present invention is directed toward the field of sales methodologies. In particular, the present invention is directed toward a novel sales methodology and system.

### BACKGROUND OF THE INVENTION

One of the most critical features of business life is the area of sales and marketing. This is unfortunately one of the most difficult areas of business and an area of high turnover and burnout. One of the challenges facing business is to provide sales. There have been a number of products, services and books designed to assist sales personnel. There have been a number of patents which are directed to sales methodologies.

U.S. Pat. No. 6,820,060 is directed to a method and apparatus for predicting analytically the probability of closing a sale. The apparatus comprises a general purpose computer having a central processing unit (CPU) and a memory for generating sales probabilities. An operating system and sales probability engine are loaded from a storage medium and executed in the memory. The sales probability engine utilizes various sales information to determine the account control level corresponding to a particular stage of the sales cycle. A sales probability is then derived by applying the account control level and the current stage of the sales cycle as indices to a sales probability look-up table.

U.S. Pat. No. 5,966,695 is directed to an electronic sales and service support system and method for identifying sales targets using a centralized database to improve marketing success. The system includes a central database that receives comprehensive information from a variety of internal and external feeds, and standardizes and households the information in a three-level hierarchy (households, customers, and accounts) for use by a financial institution. The comprehensive information stored on the central database is accessed through micromarketing workstations to generate lists of sales leads for marketing campaigns. A database engine is provided for generating logical access paths for accessing data on the central database to increase speed and efficiency of the central database. The system distributes sales leads electronically to branch networks, where the sales leads are used to target customers for marketing campaigns. The central database is accessed by workstations of a central customer information system for profiling customers, enhancing customer relationships with the financial institution, and electronically tracking sales performance during marketing campaigns.

U.S. Pat. No. 5,878,401 is directed to an apparatus that displays alternative items for items that are out of stock in a store or the like. A request for an item is entered into a sales computer. The computer determines from a database whether the requested item is available. If the item is unavailable, the computer determines alternative items that are available for sale. These available alternative items are interactively displayed for the customer. The alternative items are determined from an alternative item database wherein each item is categorized with alternative items. A mass data storage device stores an image of each alternative item. A method of determining and displaying alternative items includes the steps of: inputting a request for an item; determining the availability of the requested item and alternative items for the requested item if it is unavailable; and interactively displaying the alternative items. An electronic monitoring apparatus for a store includes: a sales computer for entering sales requests; a database for storing the request and associated information on each item ordered; a stock area computer, wherein the request is transmitted from the sales computer to the stock area computer; and a report generation system capable of generating a report selected from the group consisting of Items Requested, Items Delivered, Items Returned, Items Sold, Requests by SKU, Sales Person Report, Sales Person Summary Report, Time of Requests Analysis, and Time of Sales Analysis.

While there have been a number of technologies and inventions for facilitating sales, none have provided the type of comprehensive methodology envisioned by the present invention.

It is an object of the present invention to provide an improved method for carrying out the sales function.

It is a further object of the invention to provide an improved sales creation and tracking system.

It is a further object of the present invention to provide a comprehensive sales training and management system.

These and other objects of the invention will become clear from the detailed description which follows.

### SUMMARY OF THE INVENTION

The present invention is a comprehensive method for sales comprising of an assessment an individual's behavior, values and sales skills, the establishment of goods, the implementation of sales systems and tools to achieve the goods, tracking and implementing at least one additional sales technique.

In a further embodiment, the invention is a comprehensive method for sales comprising of an assignment of the individual's behavior, values and sales skills, the establishment of goals, the implementation of sales systems and tools to achieve the goals, sales tracking and implementing at least one additional tactical sales technology including lead generation and scripting.

In still a further embodiment, the invention is a comprehensive method for sales comprising of an assignment of the individual's behavior, values and sales skills, the establishment of goals, the implementation of sales systems and tools to achieve the goals, tracking, implementing at least one additional tactical sales technology and providing at least one management function.

### BRIEF DESCRIPTION OF THE FIGURES

FIG. 1 is a block flow diagram of the sales methodology of the present invention.

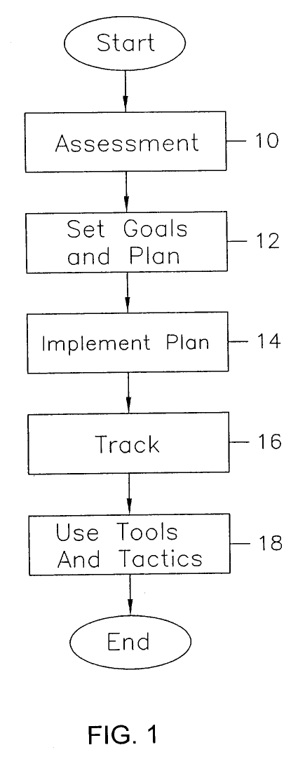

FIG. 2 is a block flow diagram of the sales methodology of the present invention.

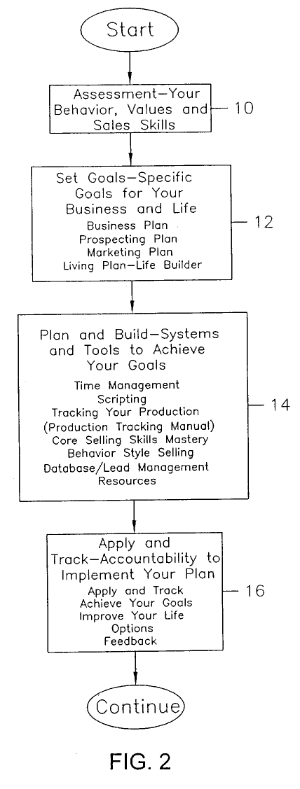

FIG. 3 is a block flow diagram of the sales methodology of the present invention.

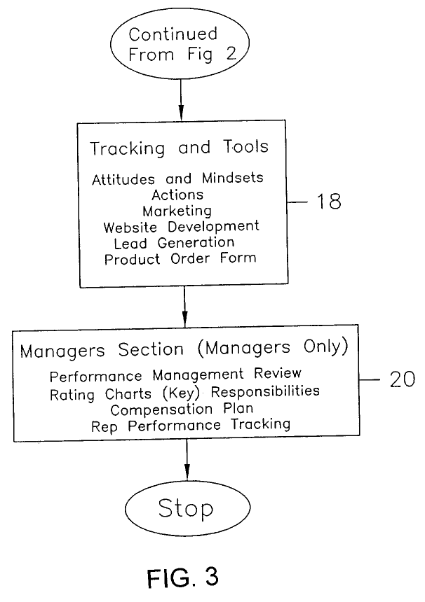

### DETAILED DESCRIPTION OF THE PRESENT INVENTION

The present invention is directed to a novel sales training and management system and methodology. In a most preferred embodiment, the invention is a multi-part methodology for facilitating and managing sales by an individual or organization. The invention comprises the following broad steps. First, the assessment of the individual salesperson's behavior 10, values, and sales skills is made. The second step is to set and establish goals for the dales person 12. The third step consists of the creation and implementation of systems and tools to achieve the goals 14. The fourth step is to track and account for the sales 16.

In more detail, the first step of the invention comprises a system for assessing behavior, values and sales skills 10. The fulfillment of this step includes creating a sales strategy index and the completion of a client self analysis form. The second step is to set goals 12. This includes setting specific goals for the salesperson's business. This step specifically includes creating a business plan which includes the itemization of goals along with the creation of a monthly, and one, three and five year plans.

Next, a prospecting plan should be created. This includes identifying the sources of business and the creation of a plan for each source. A feature of this step is the creation of a high trust referral base; a plan for handling “do not call” prospects and the identification of ideal clients.

Subsequently, a marketing plan is created. After that, a living plan is formed.

A further step incorporates a number of systems and tools to achieve the salesperson's goals 14. These tools include time management tools, including time blocking; high/low payoff sorting software for time management; and software for tracking the achievement of short term goals.

A further factor is scripting, for example, the creation of sales scripts. This includes an initial call script which is made to all prospects; pre-qualification question preparation; and the creation of a presentation/demonstration. The system further handles customer objections; closings; competitive analysis; and voice/email.

A further critical component is tracking of production 16. This includes creating monthly goals, the creation and maintenance of weekly, monthly and daily production logs/summaries; the creation and keeping of daily discipline plans; daily tally log; weekly reach/presentations/log summaries; and year to date goal tracking.

Core selling skills mastery is another feature and includes greeting skills, (such as building instant rapport); pre-qualifying, lead mastery (such as identifying “A” leads); and follow-up System for Leads Marketing.

A further aspect of the invention is the development of presentation/demonstration skills 18. It is critical to deliver a powerful presentation and eliminate objections. In addition, objection handling and closing skills are important. The sales person must ask the right questions and learn to be an active listener and satisfy the needs of the customer.

Finally, the system provides a method prioritizing and managing leads, and utilizing a lead database management system.

Further aspects of the invention incorporate management functions 20 including performance management review; along with rating charts (key) responsibilities, compensation plan, and rep performance tracking.

While the preferred embodiments of the present invention have been described and illustrated, modifications may be made by one of ordinary skill in the art without departing from the scope and spirit of the invention as defined in the appended claims.

I claim:

1. A comprehensive method for sales comprising the following steps:
(a) assignment of the individual's behavior, values and sales skills;
(b) the establishment of goals;
(c) the implementation of sales systems and tools to achieve the goals;
(d) tracking; and
(e) implementing at least one additional tactical sales technology.

2. A comprehensive method for sales comprising the following steps:
(a) assignment of the individual's behavior, values and sales skills;
(b) the establishment of goals;
(c) the implementation of sales systems and tools to achieve the goals;
(d) sales tracking; and
(e) implementing at least one additional tactical sales technology including lead generation and scripting.

3. A comprehensive method for sales comprising the following steps:
(a) assignment of the individual's behavior, values and sales skills;
(b) the establishment of goals;
(c) the implementation of sales systems and tools to achieve the goals;
(d) tracking;
(e) implementing at least one additional tactical sales technology; and
(f) providing at least one management function.
